(19) United States
(12) Patent Application Publication
(10) Pub. No.: US 2011/0050003 A1
(43) Pub. Date: Mar. 3, 2011

(54) ELECTRIC SHOCK PREVENTING DEVICE AND INFORMATION PROCESSING TERMINAL INCLUDING ELECTRIC SHOCK PREVENTING DEVICE

(75) Inventor: Toshiharu Sekino, Shizuoka (JP)

(73) Assignee: TOSHIBA TEC KABUSHIKI KAISHA, Tokyo (JP)

(21) Appl. No.: 12/709,058

(22) Filed: Feb. 19, 2010

(30) Foreign Application Priority Data
Aug. 27, 2009 (JP) 2009-196917

(51) Int. Cl. H02H 3/00

(52) U.S. Cl. 307/328

(57) ABSTRACT

There is provided an information processing terminal including an electric shock preventing device in a rear surface thereof. The electric shock preventing device includes a power source covering plate which slides to cover a connection unit; a separation preventing member which is prevented from sliding in a transverse direction by the power source covering plate if the power source covering plate exposes the connection unit, and is allowed to slide in the transverse direction if the power source covering plate covers the connection unit; and a lock installing member which prevents sliding in the transverse direction of the separation preventing member. The separation preventing member prevents separation of a printing circuit board block. Accordingly, an operator can separate the printing circuit board block only when removed a power cable from the connection unit, and electric shocks can be prevented.

### CROSS-REFERENCE TO RELATED APPLICATIONS

This application is based upon and claims the benefit of priority from the prior Japanese Patent Application No.2009-196917, filed on 27 Aug. 2009, the entire contents of which are incorporated herein by reference.

### TECHNICAL FIELD

The present invention relates to an electric shock preventing device which prevents electric shocks when a casing is opened, and an information processing terminal including the electric shock preventing device.

### BACKGROUND

An information processing terminal such as a personal computer or a POS terminal includes a connection unit which is connected with a power source. When the information processing terminal is maintained, electric shocks are prevented by removing a power cable from the connection unit.

However, when a casing of the information processing terminal is opened without removal of the power cable from the connection unit, electric shocks may be generated and internal devices thereof may be damaged.

In this respect, JP-A-10-92504 discloses a technology that an inserting hole through which a power cable is inserted is formed in a cover of a casing and the cover cannot be detached without removal of the power cable.

However, in the above described configuration, in the case of maintenance, a monitor or a printer disposed on the casing should be taken down, and then, the cover should be opened, thereby causing inconvenience.

### SUMMARY

It is an object of the present invention to provide an electric shock preventing device which is capable of preventing electric shocks in the case of maintenance without lowering objects disposed on casing, and an information processing terminal including the electric shock preventing device.

In an aspect of the present invention, the electric shock preventing device includes: a power source covering plate which slides in a first direction to cover a connection unit which is connected with a power source in the back of an information processing terminal; and a separation preventing member which is prevented from sliding by the power source covering plate if the power source covering plate exposes the connection unit to prevent separation of a printing circuit board block installed inside the information processing terminal, and is allowed to slide in a second direction if the power source covering plate covers the connection unit to allow the separation of the printing circuit board block.

### DESCRIPTION OF THE DRAWINGS

FIG. 1 is a front perspective view illustrating an information processing terminal according to the present invention;

FIG. 2 is a rear perspective view illustrating the information processing terminal according to the present invention;

FIG. 3 illustrates a state that a lock installing member according to the present invention is accommodated in a main body;

FIG. 4 illustrates a state that a separation preventing member according to the present invention is released;

FIG. 5 illustrates a state that the separation preventing member according to the present invention is detached;

FIG. 6 illustrates a state that a printing circuit board block according to the present invention is separated;

FIG. 7 is a bottom perspective view illustrating the separated printing circuit board block according to the present invention;

FIG. 8 is an exploded perspective view illustrating a power source covering plate according to the present invention;

FIG. 9 is an exploded perspective view illustrating the lock installing member according to the present invention;

FIG. 10 illustrates a state that the separation preventing member according to the present invention is locked;

FIG. 11 illustrates a state that the separation preventing member according to the present invention is released from locking; and

FIG. 12 illustrates an operation of a separation lever according to the present invention.

### DETAILED DESCRIPTION

Throughout this description, the embodiments and examples shown should be considered as exemplars, rather than limitations on the apparatus and methods of the present invention.

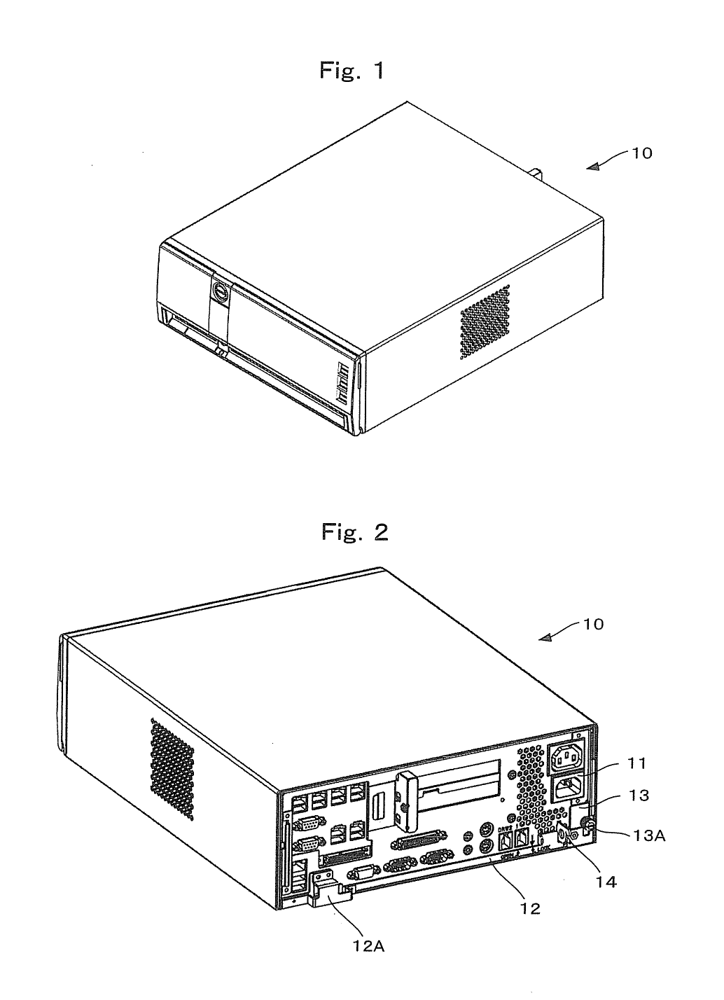

Hereinafter, an electric shock preventing device and an information processing terminal including the electric shock preventing device according to an exemplary embodiment of the present invention will be described in detail with reference to the accompanying drawings. FIG. 1 is a front perspective view illustrating an information processing terminal 10 according to the present embodiment; and FIG. 2 is a rear perspective view illustrating the information processing terminal 10. The information processing terminal 10 includes, for example, a computer, a POS terminal, a DVD player or the like, but is not limited thereto.

As shown in FIGS. 1 and 2, the information processing terminal 10 according to the present embodiment includes an electric shock preventing device. The electric shock preventing device includes a power source covering plate 13 which slides in a first direction, that is, in a longitudinal direction, to cover a connection unit 11 which is connected with a power source in the back of the information processing terminal 10; a locking member 13A which fastens and locks the power source covering plate 13; a separation preventing member 12 which is prevented from sliding in a second direction, that is, in a transverse direction by the power source covering plate 13 if the power source covering plate 13 exposes the connection unit 11, and is allowed to slide in the transverse direction if the power source covering plate 13 covers the connection unit 11; and a lock installing member 14 which prevents the transverse directional sliding of the separation preventing member 12. The separation preventing member 12 includes a lever cover 12A. The separation preventing member 12 is prevented from the transverse directional sliding by the power source covering plate 13.

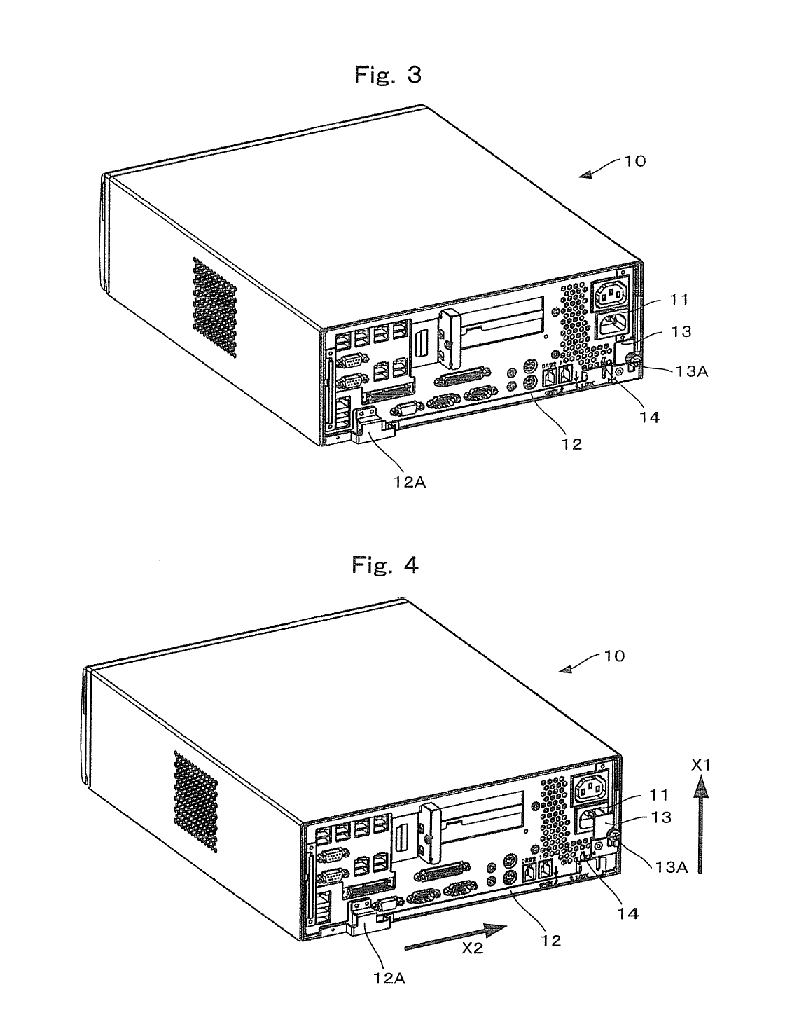

FIG. 3 illustrates a state that the lock installing member 14 slides in a third direction, that is, in an inside direction and is accommodated inside a main body. As shown in FIG. 3, if a lock is not installed, the lock installing member 14 is accommodated inside the main body and allows the transverse directional sliding of the separation preventing member 12.

FIG. 4 illustrates a state that the separation preventing member 12 is released. As shown in FIG. 4, if a power cable is removed from the connection unit 11, the locking member 13A is loosened so that the power source covering plate 13 is allowed to slide in an arrow X1 direction.

If the power source covering plate 13 slides in the arrow X1 direction, the power source covering plate 13 covers the connection unit 11, and thus, the connection of the power cable is not possible. Further, the separation preventing member 12 is released from the sliding prevention by the creation of a gap below the power source covering plate 13 with just enough space for the separation preventing member 12 to enter. Thus, the separation preventing member 12 is allowed to slide in the transverse direction, that is, in an arrow X2 direction.

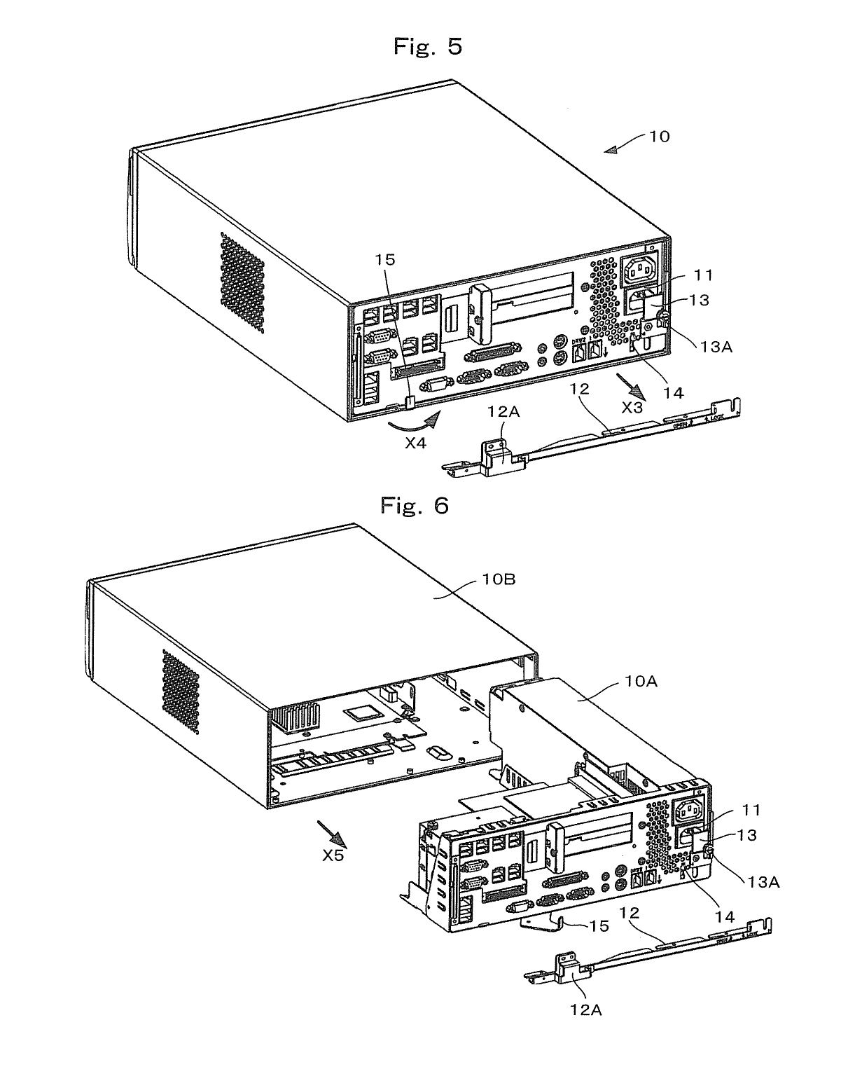

FIG. 5 illustrates a state that the separation preventing member 12 is detached. As shown in FIG. 5, the separation preventing member 12 slides in the transverse direction, and then can be withdrawn in an outside direction, that is, in an arrow X3 direction.

The information processing terminal 10 includes a separation lever 15 which is rotatably locked to a printing circuit board block 10A. In the information processing terminal 10, the printing circuit board block 10A is provided in a separable manner as an electronic circuit group in which a printing circuit board can be installed. If the separation lever 15 is pressed and rotated in an arrow X4 direction, the printing circuit board block 10A is separated from the information processing terminal 10.

FIG. 6 illustrates a state that the printing circuit board block 10A is separated. As shown in FIG. 6, the separated printing circuit board block 10A can be withdrawn from a casing 10B which covers the printing circuit board block 10A in an arrow X5 direction. The printing circuit board block 10A is provided with slots for extension of the printing circuit board, and a user can perform maintenance without being concerned about electric shocks.

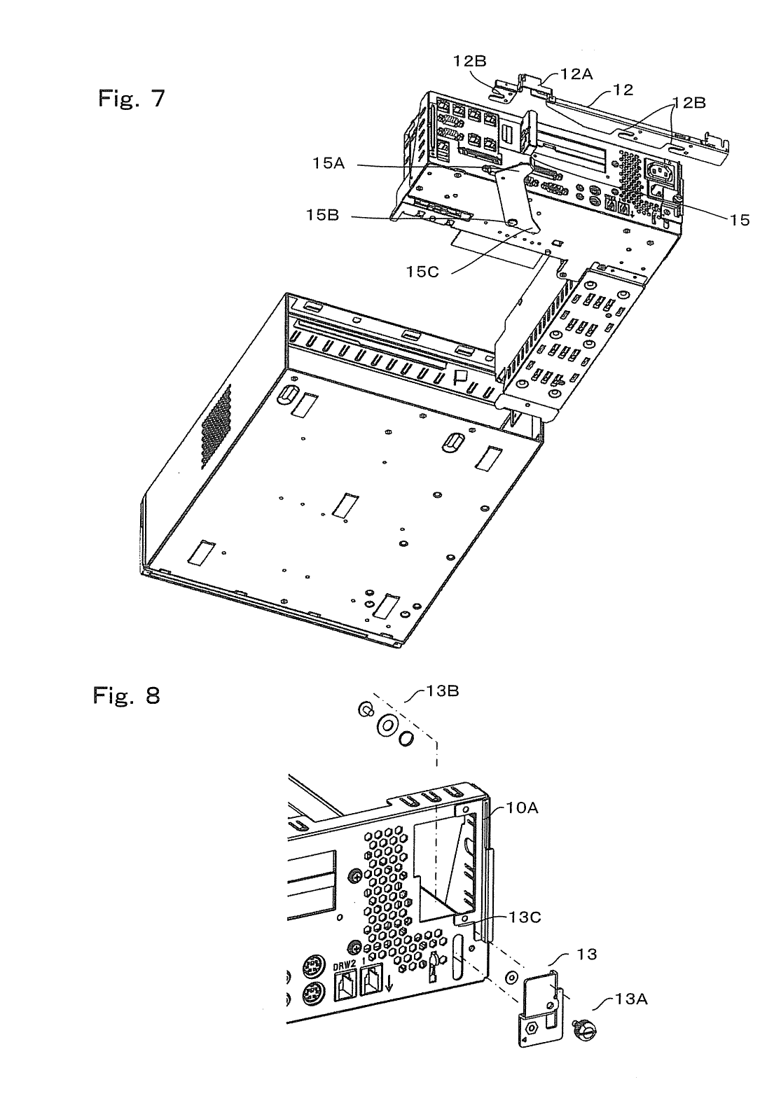

FIG. 7 is a bottom perspective view illustrating the separated printing circuit board block 10A. As shown in FIG. 7, the printing circuit board block 10A is provided with the separation lever 15 in a rotatable manner. The separation lever 15 includes a lever portion 15A, a pressing portion 15C, and a rotation locking portion 15B disposed between the lever portion 15A and the pressing portion 15C to lock the separation lever 15 in a rotatable manner.

The lever portion 15A is a pressing point, the rotation locking portion 15B is a supporting point, and the pressing portion 150 is an operating point. According to the principle of leverage, the printing circuit board block 10A is separated from the information processing terminal 10.

The separation preventing member 12 includes a hook portion 12B which is a cutout of a hook shape on a side thereof facing the printing circuit board block 10A.

FIG. 8 is an exploded perspective view illustrating the power source covering plate 13. As shown in FIG. 8, the power source covering plate 13 is locked to the printing circuit board block 10A in a slidable manner by inserting a fastening member 13B which includes a pin and a washer in a sliding hole 13C provided in the printing circuit board block 10A.

The locking member 13A locks the power source covering plate 13 to the printing circuit board block 10A. The power source covering plate 13 is allowed to slide as the locking member 13A is loosened.

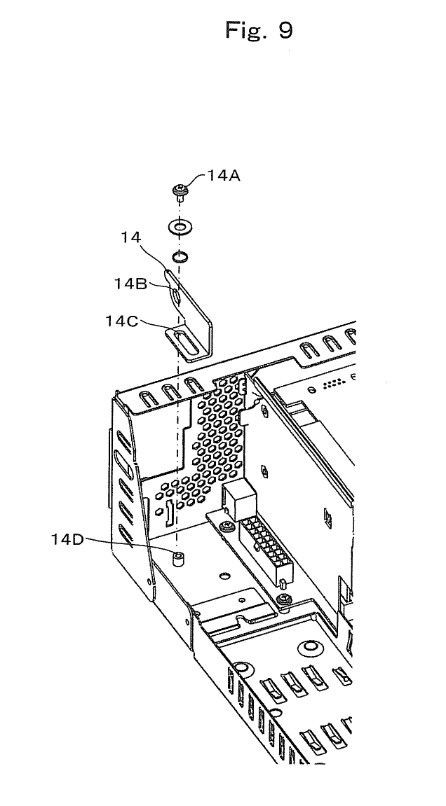

FIG. 9 is an exploded perspective view illustrating the lock installing member 14. As shown in FIG. 9, the lock installing member 14 is formed with a lock installation hole 14B for installation of the lock which prevents sliding in the third direction, and an installation hole 14C which locks the lock installing member 14 in a slidable manner to the printing circuit board block 10A. A screw 14A passes the installation hole 14C, and then is coupled with a sliding pin 14D provided in the printing circuit board block 10A. The sliding pin 14D has a height larger than the thickness of the lock installing member 14.

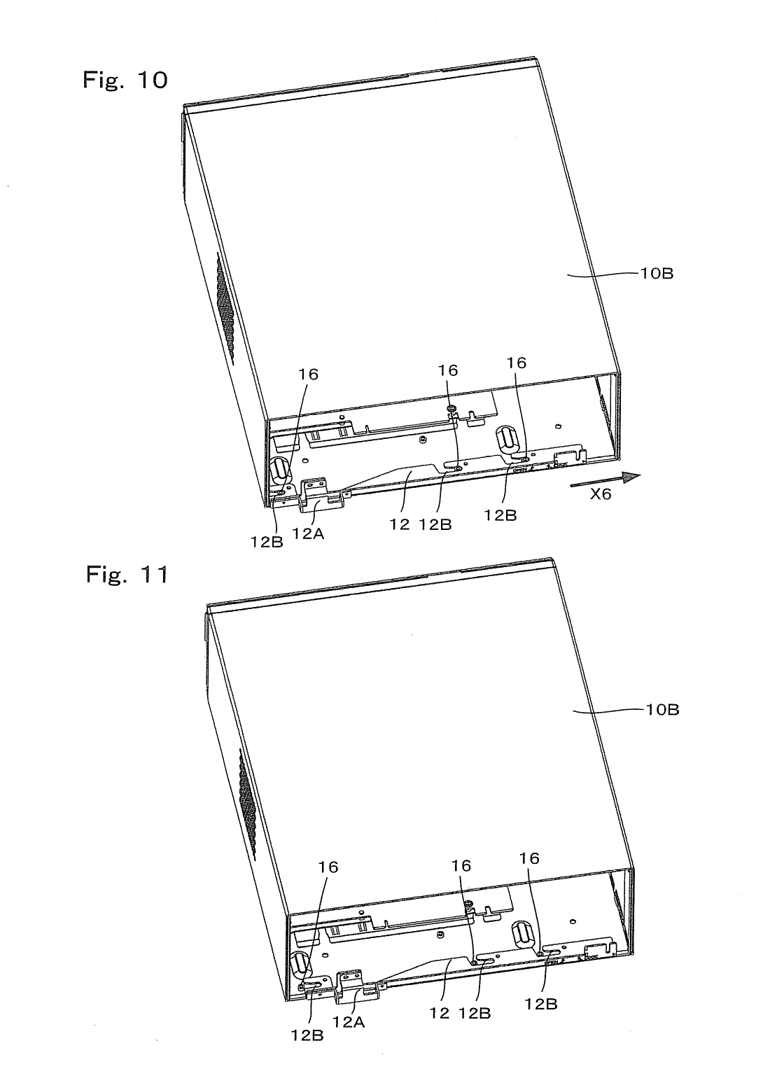

FIG. 10 illustrates a state that the separation preventing member 12 is locked; and FIG. 11 illustrates a state that the separation preventing member 12 is released from having been locked. In FIGS. 10 and 11, illustration of the printing circuit board block 10A is omitted. As shown in FIGS. 10 and 11, the casing 10B includes therein a locking protrusion 16 of a pin shape.

The separation preventing member 12 is locked to the casing 10B by hooking the hook portion 12B on the locking protrusion 16. The separation preventing member 12 is released from having been locked by sliding in a transverse direction, that is, in an arrow X6 direction, and thus can be detached from the casing 10B.

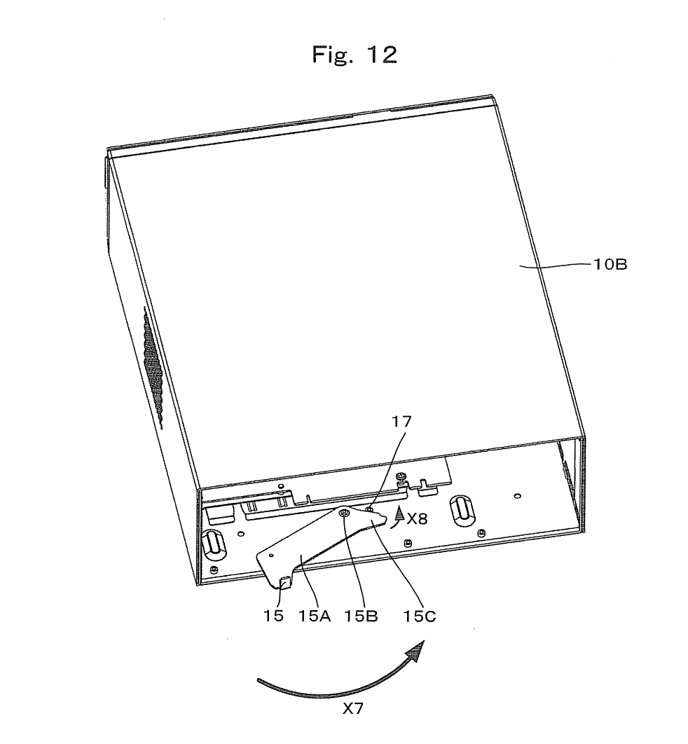

FIG. 12 illustrates an operation of the separation lever 15. In FIG. 12, illustration of the printing circuit board block 10A is omitted. As shown in FIG. 12, if the separation lever 15 rotates in an arrow X7 direction, the pressing portion 150 rotates in an arrow X8 direction. The pressing portion 15C presses a separating protrusion 17 which is a protrusion provided in the casing 10B. The printing circuit board block 10A is separated from the information processing terminal 10 by a return action of the separating protrusion 17.

As described above, the information processing terminal 10 according to the embodiment includes the electric shock preventing device at a rear surface thereof. The electric shock preventing device includes the power source covering plate 13 which covers the connection unit 11 by the sliding movement; the separating preventing member 12 which is prevented from sliding in the transverse direction by the power source covering plate 13 if the power source covering plate 13 exposes the connection unit 11, and is allowed to slide in the transverse direction if the power source covering plate 13 covers the connection unit 11; and the lock installing member 14 which prevents the transverse directional sliding of the separation preventing member 12. The separation preventing member 12 prevents separation of the printing circuit board block 10A. Accordingly, an operator can separate the printing circuit board block 10A for the first time when removing the power cable from the connection unit 11 without lowering objects disposed on the casing, and electric shocks can be prevented.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An electric shock preventing device comprising:
a power source covering plate which slides in a first direction to cover a connection unit which is connected with a power source in the back of an information processing terminal; and
a separation preventing member which is prevented from sliding by the power source covering plate if the power source covering plate exposes the connection unit to prevent separation of a printing circuit board block installed inside the information processing terminal, and is allowed to slide in a second direction if the power source covering plate covers the connection unit to allow the separation of the printing circuit board block.

2. The device according to claim 1, further comprising:
a lock installing member formed with a lock installation hole for installation of a lock which prevents sliding in a third direction, and preventing the sliding of the separation preventing member in the second direction by sliding in a direction opposite to the third direction.

3. The device according to claim 2, further comprising:
a separation lever rotatably locked to the printing circuit board block, and pressing a separating protrusion which is provided in a casing of the information processing terminal according to rotation thereof and separating the printing circuit board block from the casing.

4. An information processing terminal comprising:
a printing circuit board block which is an electronic circuit group in which a printing circuit board can be installed;
a casing which covers the printing circuit board block; and
an electric shock preventing device comprising: a power source covering plate sliding in a first direction to cover a connection unit which is connected with a power source in the back of the printing circuit board block; and a separation preventing member which is prevented from sliding by the power source covering plate if the power source covering plate exposes the connection unit to prevent separation of a printing circuit board block installed inside the information processing terminal, and is allowed to slide in a second direction if the power source covering plate covers the connection unit to allow the separation of the printing circuit board block.

5. The terminal according to claim 4,
wherein the electric shock preventing device further comprises: a lock installing member formed with a lock installation hole for installation of a lock which prevents sliding in a third direction, and preventing the sliding of the separation preventing member in the second direction by sliding in a direction opposite to the third direction.

6. The terminal according to claim 4,
wherein the electric shock preventing device further comprises: a separation lever rotatably locked to the printing circuit board block, and pressing a separating protrusion which is provided in the casing of the information processing terminal according to rotation thereof and separating the printing circuit board block from the casing.
